(19) United States
(12) Patent Application Publication
(10) Pub. No.: US 2013/0242250 A1
(43) Pub. Date: Sep. 19, 2013

(54) EYEWEAR HAVING A MESH EYE SHIELD

(71) Applicant: Phillip David Hall, Masterton (NZ)

(72) Inventor: Phillip David Hall, Masterton (NZ)

(21) Appl. No.: 13/990,749

(22) PCT Filed: Dec. 2, 2010
(86) PCT No.: PCT/NZ2010/000241

§ 371 Date: May 30, 2013

(51) Int. Cl. G02C 7/16

(52) U.S. Cl. CPC G02C 7/16
USPC 351/46

(57) ABSTRACT

Eyewear having an eye shield of mesh where the mesh has been formed by chemical etching is disclosed. The chemical etching involves the steps of applying a protective coating to a suitable sheet material, creating openings in the protective coating, and subjecting the sheet material to a suitable liquid such that mesh spaces are formed at the openings. In other embodiments of the invention the sheet may be exposed to a gaseous acid or an alkali.

### FIELD OF INVENTION

This invention relates to eyewear having a mesh eye shield.

### BACKGROUND

It is known to form eyewear having an eye shield which is made from mesh. It is an object of a preferred form of the invention to provide novel and inventive mesh eyewear which provides a useful alternative to at least some of such known products

The term “comprising” or derivatives thereof, if and when used in this document should be interpreted non-exclusively, eg to mean “consisting of or including”.

### SUMMARY OF THE INVENTION

According to one aspect of the invention there is provided eyewear having an eye shield of mesh where the mesh has been formed by chemical etching involving the steps of applying a protective coat to a suitable sheet material, creating openings in the protective material, and subjecting the sheet material to a suitable liquid or gas such that mesh spaces are formed at the openings.

Preferably the mesh contains openings that are generally hexagonal in shape.

Preferably there are two separate eye shields, one for each eye.

Preferably the eyewear is in the form of goggles.

Optionally the eyewear is in the form of eye glasses.

Preferably the mesh is formed of a suitable metallic and/or plastic substance.

Preferably the mesh is formed of stainless steel.

Preferably the chemical etching involves the steps of applying a protective coating to a suitable sheet material, creating openings in the protective coating, and subjecting the sheet material to a suitable liquid such that mesh spaces are formed at the openings.

### DESCRIPTION OF THE DRAWINGS IMAGES

Some preferred forms of the invention will now be described by way of example and with reference to the accompanying drawings, of which

FIG. 1 is a perspective view of a pair of safety goggles, and

FIG. 2 is a front magnified view showing an eye shield forming part of the safety goggles.

### DETAILED DESCRIPTION

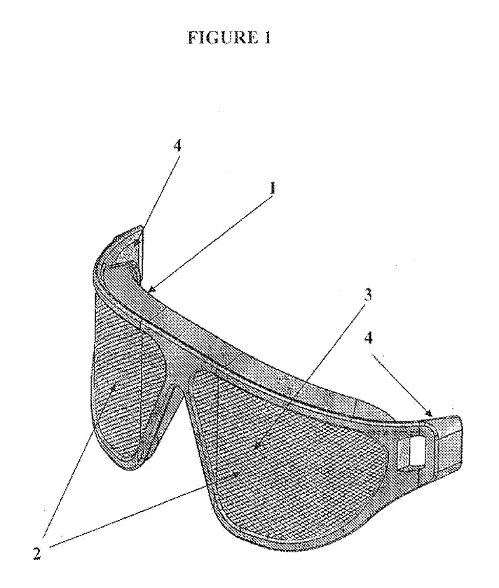

Referring to FIG. 1 the eyewear 1 has an eye shield 2 which consists of two separate pieces. In other embodiments of the invention the eye shield 2 may consist of one piece. The eye shield 2 is made of mesh 3. The mesh 3 is made of a suitable metallic and/or plastic substance such as stainless steel. The mesh 3 is formed by chemical etching. The chemical etching involves the steps of applying a protective coating to a suitable sheet material, creating openings in the protective coating, and subjecting the sheet material to a suitable liquid such that mesh spaces are formed at the openings. in other embodiments of the invention the sheet may be exposed to a gaseous acid or an alkali rather than the liquid mentioned above.

The eyewear 1 has a pair of strap connectors 4 on the right and on the left of the rear facing side of the goggles. FIG. 1 does not show a strap for attaching the eyewear 1 to a user's head but according to one preferred embodiment of the invention the eyewear 1 is secured to a user's head by a flexible head strap that is attached at each end to the strap connectors 4 respectively, In other embodiments of the invention the eyewear 1 can be secured to a user's head with two arms curved at each end to form ear hooks as is normal with eye glasses. When the eyewear I is worn the eye shield 2 protects the eyes.

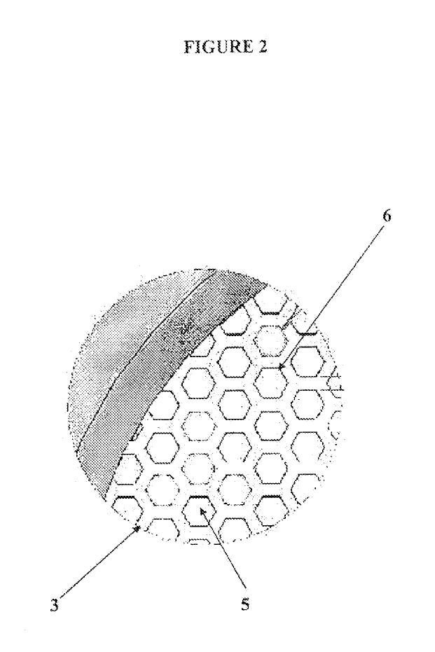

Referring to FIG. 2, a magnified view of the mesh 3 shows that the mesh 3 consists of openings 5 which are generally hexagonal in shape 6. The hexagonal shape of the openings 5 in the mesh 3 give the mesh more strength than would be the case with quadrilateral-shaped mesh spaces.

While some preferred forms of the invention have been described by way of example it should be appreciated that modifications and improvements can occur without departing from the scope of the following claims.

1. Eyewear having an eye shield of mesh where the mesh has been formed by chemical etching involving the steps of applying a protective coat to a suitable sheet material, creating openings in the protective material, and subjecting the sheet material to a suitable liquid or gas such that mesh spaces are formed at the openings.

2. Eyewear according to claim 1, wherein the mesh contains openings that are generally evenly hexagonal in shape.

3. Eyewear according to claim 1, wherein there are two separate eye shields, one for each eye.

4. Eyewear according to claim 1, wherein the eyewear is in the form of goggles.

5. Eyewear according to claim 1, wherein the eyewear is in the form of eye glasses.

6. Eyewear according to claim 1, wherein the mesh is formed of a suitable metallic and/or plastic substance.

7. Eyewear according to claim 1, wherein there are two separate eye shields, one for each eye, and wherein the mesh is formed of stainless steel.

8. Eyewear having two eye shields of mesh where the mesh has been formed by chemical etching involving the steps of
applying a protective coat to a suitable sheet material,
creating openings in the protective material, and
subjecting the sheet material to a suitable liquid or gas such that look-through mesh spaces are formed at the openings, each of said eye shields arranged so as to be suitable for use with only one eye at a time, the spaces being substantially uniform in size and shape across substantially all of each eye shield.

9. Eyewear according to claim, 8 wherein the spaces are each an even hexagonal shape.

10. Eyewear according to claim 8 in the form of glasses, wherein the spaces are each an even hexagonal shape.

11. Eyewear according to claim 8 in the form of goggles, wherein the spaces are each an even hexagonal shape.
